(19) United States
(12) Patent Application Publication
(10) Pub. No.: US 2019/0266585 A1
(43) Pub. Date: Aug. 29, 2019

(54) Smart Shopping Cart

(71) Applicant: Kristopher Johnson, Durham, NC (US)

(72) Inventor: Kristopher Johnson, Durham, NC (US)

(21) Appl. No.: 16/284,593

(22) Filed: Feb. 25, 2019

Related U.S. Application Data
(60) Provisional application No. 62/635,194, filed on Feb. 26, 2018.

(51) Int. Cl. G06Q 20/20; B62B 5/00; B62B 3/14

(52) U.S. Cl. CPC G06Q 20/208; G06Q 20/204; B62B 3/1424; B62B 5/0096

(57) ABSTRACT

A shopping cart having an affixed circuit board and computer readable memory. The circuit board and memory are operably connected to a first bar code scanner and a second bar code scanner, wherein the first scanner is detachable for scanning larger items while the second scanner is permanently affixed on a sidewall of the cart. A display screen is disposed on the handle of the cart. The shopping cart has a plurality of wheels, wherein the wheels selectively move between a locked and unlocked state. The wheels unlock upon an identification card actuating an electronic locking mechanism. The cart is separated into two main compartments for item storage, wherein additional compartments for personal belongings and bagging items are included. A receipt printer is also operably connected to the logic and computer readable memory. Weight sensors are disposed on a bottom surface of the two main item storage compartments.

### CROSS REFERENCE TO RELATED APPLICATIONS

This application claims the benefit of U.S. Provisional Application No. 62/635,194 filed on Feb. 26, 2018. The above identified patent application is herein incorporated by reference in its entirety to provide continuity of disclosure.

### BACKGROUND OF THE INVENTION

The present invention relates to smart shopping carts. More specifically, the present invention relates to a smart shopping cart having logic and memory are operably connected to a bar code scanner wherein the scanner is disposed on a sidewall of the cart.

Many people get frustrated when shopping due to the inability to find a desired item, disliking publicly purchasing private or potentially embarrassing items, and also being surprised by the total cost of all the purchased items at checkout. Additionally, many stores are plagued by low manpower at checkout, leading to excessively long lines that a customer must wait in which wastes time and energy. Alternatively, self-checkout lanes can be confusing, hard to use, and just as time-consuming as regular check-out lines can be. Therefore, a device that can streamline the shopping process by keeping an accurate total of items as the customer is shopping, having an in-store food navigation program, and checkout the user with a simple swipe of a credit card is desired.

Devices have been disclosed in the known art that relate to smart shopping carts and shopping cart attachments. These include devices that have been patented and published in patent application publications. One of these devices relates to a self-service cart system to provide speed throughput at a checkout counter to reduce space devoted to checkout counters. Another device relates to a device and system for precisely inventorying items placed within a user-portable container. These devices in the known art, however, fail to disclose a smart shopping cart having a circuit board and memory operably connected to both an affixed and detachable bar code scanner also possessing a weight sensor on the bottom surface of the main storage compartments of the cart.

In light of the devices disclosed in the known art, it is submitted that the present invention substantially diverges in design elements from the prior art and consequently it is clear that there is a need in the art for an improvement to existing smart shopping carts. In this regard, the instant invention substantially fulfills these needs.

### SUMMARY OF THE INVENTION

In view of the foregoing disadvantages inherent in the known types of smart shopping carts now present in the known art, the present invention provides a smart shopping cart with attached weight sensor on the bottom surface of the cart wherein the same can be utilized for providing convenience for the user when shopping and streamlining the checkout process.

It is therefore an objective of the present invention to provide a new and improved smart shopping cart that has all of the advantages of the known art and none of the disadvantages. The present system comprises a cart frame having a first storage area and a second storage area wherein the first storage area extends outwardly from the cart frame and has a planar bottom having sidewalls defining an open-topped enclosure and the second storage area extends outwardly from the bottom of the cart frame. Sensors disposed on the surface of the planar bottom of the first storage area and the second storage area are configured to detect the weight of objects placed on them. A first pair of wheels is disposed on the bottom of the cart frame at the connection with the second storage area and affixed in a forward orientation, while a second pair of wheels is rotatably affixed to a distal end of the second storage area.

It is another objective of the present invention is to provide a smart shopping cart wherein a display screen operably attached to a circuit board and a power source is disposed on a handle running across the top of the cart frame and has a touchscreen capable monitor.

Another objective of the present invention is to provide a smart shopping cart wherein a first bar code scanner is included which is selectively detachable from the smart shopping cart to allow a user to scan larger items that cannot be lifted up to the affixed bar code scanner.

Another objective of the present invention is to provide a smart shopping cart wherein the display screen includes attached features such as a credit card reader, a second bar code scanner, and a receipt printer to allow for a user to keep track of, and pay for, items scanned and placed within the first and second storage areas.

It is another objective of the present invention to provide a smart shopping cart wherein additional areas for storage of personal belongings and bagging items are disposed on the outer surface of the sidewalls.

Yet another objective of the present invention is to provide a smart shopping cart wherein a locking mechanism is included on the first pair of wheels and operably connected to the circuit board and power source and configured to unlock after having received the appropriate information via the card reader and display screen.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the smart shopping cart with inset view of first pair of wheels.

FIG. 2 shows a perspective view of an embodiment of the smart shopping cart showing sensors within the first and second storage areas.

FIG. 3 shows a perspective view of an embodiment of the smart shopping cart showing the display screen and attached bar code scanner.

FIG. 4 shows a schematic view of the electronic components of an embodiment of the smart shopping cart.

FIG. 5 shows a perspective view of an embodiment of the smart shopping cart showing the display screen and attachments.

### DETAILED DESCRIPTION OF THE INVENTION

Reference is made herein to the attached drawings. Like reference numerals are used throughout the drawings to depict like or similar elements of the smart shopping cart. For the purposes of presenting a brief and clear description of the present invention, the preferred embodiment will be discussed as used for weighing and totaling the amount of items and price of inventory being purchased by a user of the smart shopping cart. The figures are intended for representative purposes only and should not be considered to be limiting in any respect.

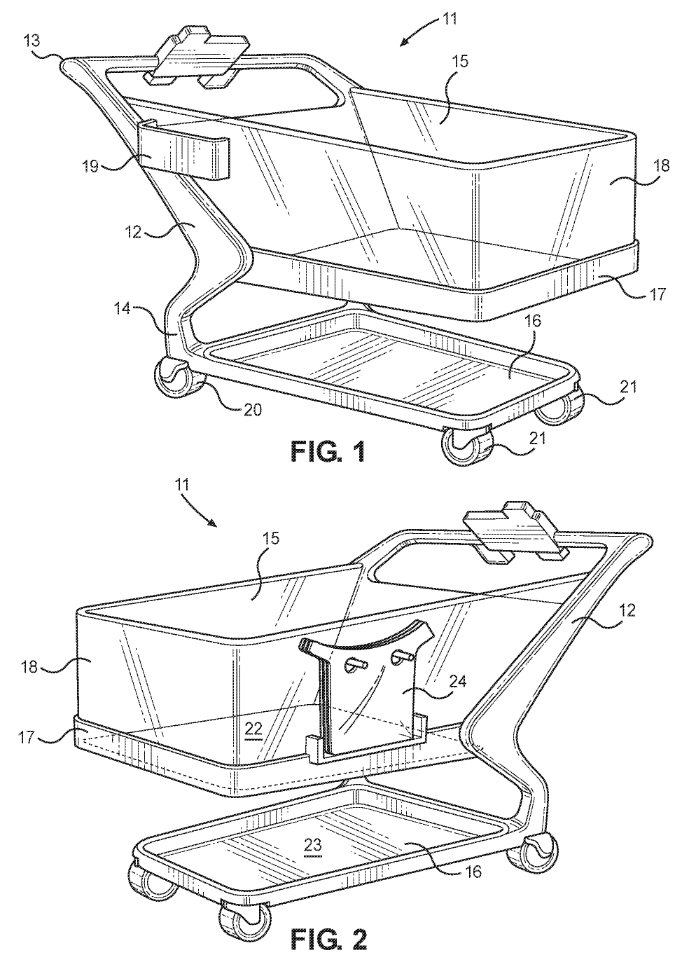

Referring now to FIG. 1, there is shown a perspective view of an embodiment of the smart shopping cart with inset view of first pair of wheels. The smart shopping cart 11 comprises a cart frame 12 having a top end 13 and a bottom end 14 wherein a first storage area 15 and a second storage 16 area extend outwardly therefrom. The first storage area 15 is comprised of a planar bottom surface 17 having a plurality of sidewalls 18 extending upwards from edges thereon and connecting to define an enclosure having an open top. The first storage area 15 is disposed on the cart frame 12 at a point between the top end 13 and the bottom end 14. The second storage area 16 extends perpendicularly from the bottom end 14 of the cart frame 12 and comprises a planar surface having an upward facing rim around an edge thereof. A separate compartment 19 disposed on an exterior surface of a sidewall 18 of the first storage area 15 can be utilized to store and carry the personal belongings of a user, such as a handbag or purse. In some embodiments of the smart shopping cart 11, the separate compartment 19 may be comprised of either a rigid construction or a fabric enclosure to hold the personal belongings of a user.

A first and second pair of wheels 20 and 21 are disposed on the bottom of the second storage area 16 to allow the smart shopping cart 11 to be maneuvered around by a user. The first pair of wheels 20 are disposed on the bottom of the cart frame 12 at the connection with the second storage area 16 and affixed in a forward-facing orientation towards the distal end of the second storage area 16. In the illustrated embodiment, the second pair of wheels 21 are rotatably affixed to a bottom surface of the distal end of the second storage area 16. In some embodiments, a locking mechanism is included on the first pair of wheels 20 and configured to open and release depending on whether the smart shopping cart 11 has been activated. In some embodiments, the smart shopping cart 11 requires a payment to be processed before a user can utilize the smart shopping cart 11.

Referring now to FIG. 2, there is shown a perspective view of an embodiment of the smart shopping cart showing sensors within the first and second storage areas. The first and second storage areas 15 and 16 are adapted to receive and store the items selected by a user to be purchased. A first sensor 22 is included on the planar bottom surface 17 of the first storage area 15 and operably attached to a circuit board and power source located within the cart frame 12. A second sensor 23 is included on the planar surface of the second storage area 16 and also operably connected to the circuit board and power source located within the cart frame 12. The first and second sensors 22 and 23 are configured to calculate the weight of objects placed within the first and second storage areas 15 and 16. In one embodiment of the smart shopping cart 11, a bagging area 24 is disposed on the exterior of a sidewall 18 of the first storage area 15. The bagging area 24 comprising metal hooks adapted to receive a bundle of plastic bags thereon. A ledge extends outward from the exterior surface of a sidewall of the first storage area 15 underneath the metal hooks of the bagging area 24 to provide for a stable platform for a user to rest items that have been placed in the bags. A user may pull off an individual bag to hold similar items for convenient storage as well as accurate measurement.

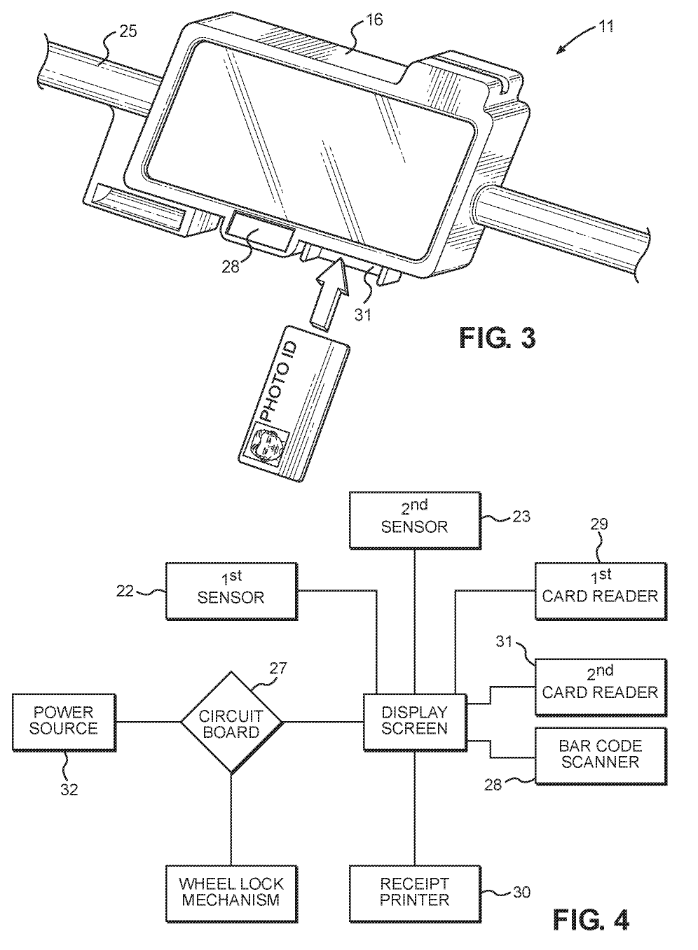

Referring now to FIGS. 3 and 4, there is shown a perspective view of an embodiment of the smart shopping cart showing the display screen and attached bar code scanner and a schematic view of the electronic components of an embodiment of the smart shopping cart, respectively. A handle 25 runs across the top end of the cart frame to allow a user to grip and push the smart shopping cart 11. A display screen 26, which is operably attached to the circuit board 27 and power source 32, is disposed in a central location on the handle 25 running across the top end of the cart frame. In the illustrated embodiment, the display screen 26 comprises a full color liquid crystal display (LCD) touchscreen monitor for ease of use. The display screen 26 includes an attached bar code scanner 28 for scanning selected items before being placed in either the first or the second storage areas. The bar code scanner 28 corresponds with an inventory list uploaded on the circuit board to calculate and tally the unit price or weight price of each item. In some embodiments of the smart shopping cart 11, a second bar code scanner is included within a selectively detachable handheld device which is wired and operably connected to the circuit board 27 and power source 32 which allows users to scan larger items without having to use the affixed bar code scanner 28 attached to the display screen 26. The first and second sensors 22 and 23 detect the weight of each item placed within the first and second storage areas and checks the unit weight against the weight on file for that specific item. For items priced by weight, a user can scan the bar code and place the bagged items into the first or second storage areas to be weighted or look up and select the specific item on the display screen before being weighed within the storage areas. In some embodiments, the identification received within the second card reader 31 also acts to release the brake mechanism on the first pair of wheels to allow a user to freely move the smart shopping cart 11 and begin their shopping experience.

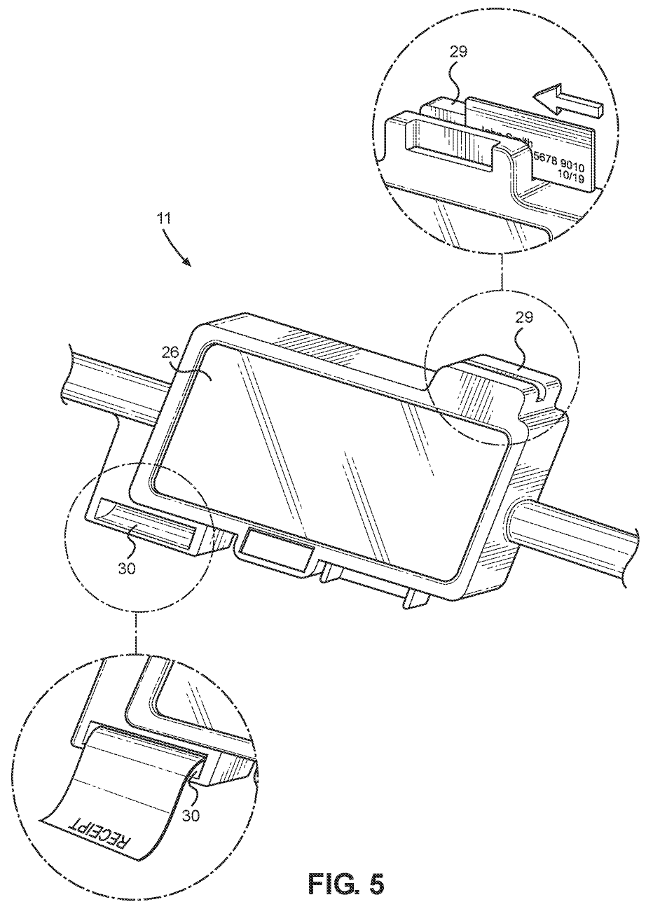

Referring now to FIG. 5, there is shown a perspective view of an embodiment of the smart shopping cart showing the display screens and attachments. A first card reader 29 is also operably attached to the display screen 26 and comprises a credit card scanner that has both swipe and chip reading capabilities. After the user has concluded their shopping and wishes to check out, they may swipe their card or slide into the chip reading slot of the first card reader 29 to allow for the display screen 26 to process their information for payment. A receipt printer 30 is operably connected to the display screen 26. After the total inventory of the cart has been tallied and the goods have been paid for, a receipt and any applicable promotions or coupons will be printed out for a user on site. In one embodiment of the smart shopping cart 11, a second card reader 31 is operably attached to the display screen 26 and disposed on a bottom portion thereof. The second card reader 31 is adapted to receive an identification card within a slot to provide the smart shopping cart 11 with the user's information to allow for an individualized experience such as a rewards system and promotions tailored to the user. The identification card is stored within the second card reader 31 until payment has been received for purchased goods.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A smart shopping cart, comprising:
a cart frame having a top end and a bottom end;
a first storage area protruding outwardly from the cart frame and comprising a planar bottom surface wherein sidewalls extend upward from edges thereon and connect to define an enclosure having an open top;
a second storage area disposed underneath, and parallel to, the first storage area comprised of a planar surface wherein the second storage area extends outwardly from the bottom end of the cart frame;
a first pair of wheels disposed at the bottom of the cart frame at the connection with the second storage area and affixed in a forward orientation;
a second pair of wheels rotatably affixed at the distal end of the second storage area;
a first sensor disposed on the surface of the planar bottom of the first storage area and operably connected to a circuit board and a power source disposed within the cart frame;
a second sensor disposed on the surface of the second storage area also operably connected to the circuit board and power source disposed within the cart frame.

2. The smart shopping cart of claim 1, wherein the first and second sensors are configured to detect weight placed upon them.

3. The smart shopping cart of claim 1, wherein a handle bar is disposed across the top end of the cart frame and adapted to receive the hands of a user.

4. The smart shopping cart of claim 3, wherein a display screen is disposed on the handle bar running across the top end of the cart frame and operably connected to the circuit board and power source disposed within the cart frame.

5. The smart shopping cart of claim 1, wherein a first laser bar code scanner is included within a selectively detachable handheld scanner having a wired and operable connection with the circuit board and power source.

6. The smart shopping cart of claim 4, wherein the display screen includes a second laser bar code scanner attached thereto.

7. The smart shopping cart of claim 4, wherein the display screen includes a first attached card reader capable of reading a credit card via strip swiping and chip scanning.

8. The smart shopping cart of claim 4, wherein the display screen is comprised of a touchscreen monitor.

9. The smart shopping cart of claim 4, wherein the display screen includes an attached receipt printer.

10. The smart shopping cart of claim 4, wherein the display screen includes a second attached card reader adapted to receive and store an identification card.

11. The smart shopping cart of claim 4, wherein the control circuit further comprises a logic thereon, the logic configured to display an inventory of a given store on the display screen, and wherein a user can selectively choose individual items from the inventory to purchase.

12. The smart shopping cart of claim 10, wherein the logic is configured to calculate the total prices of items selected from the inventory and items by weight detected by the sensors.

13. The smart shopping cart of claim 4, wherein the display screen is adapted to display a running total of the price of all items included in the cart.

14. The smart shopping cart of claim 1, wherein a plurality of metal hooks configured to receive a plurality of plastic bags thereon are disposed on an exterior surface of a sidewall of the first storage area.

15. The smart shopping cart of claim 13, wherein a planar ledge extends outwardly from an exterior surface of a sidewall of the first storage area underneath the plurality of metal hooks to provide a flat and stable surface to rest food items that are in the process of being bagged.

16. The smart shopping cart of claim 1, wherein a compartment for storing personal items is disposed on the exterior of a sidewall of the first storage area.

17. The smart shopping cart of claim 1, wherein the first pair of wheels disposed on the bottom of the cart frame includes a locking mechanism operably connected to the circuit board and power source and adapted to remain in a locked position until activated using a credit card.

18. The smart shopping cart of claim 1, wherein the power source disposed within the cart frame and operably attached to the circuit board is comprised of a rechargeable battery.

19. The smart shopping cart of claim 1, wherein the second storage area includes a rim along the perimeter thereof which extends orthogonally upward therefrom to form an enclosure for storing food items.
